(19) United States
(12) Patent Application Publication
(10) Pub. No.: US 2016/0021543 A1
(43) Pub. Date: Jan. 21, 2016

(54) METHOD AND SYSTEM FOR AD HOC CELLULAR PBX

(71) Applicant: Andrew Jay Diamond, Marietta, GA (US)

(72) Inventor: Andrew Jay Diamond, Marietta, GA (US)

(21) Appl. No.: 13/732,969

(22) Filed: Jan. 2, 2013

Related U.S. Application Data
(60) Provisional application No. 61/631,438, filed on Jan. 5, 2012.

(51) Int. Cl. H04W 16/16; H04M 7/00; H04W 76/02

(52) U.S. Cl. CPC H04W 16/16; H04W 76/023; H04M 7/009; H04W 84/18

(57) ABSTRACT

The present invention relates in general to the creation of cellular phone based communities at the network level. More particularly relates to a method, system and apparatus for organizing phones and other devices running phone based operating systems into a common exchange, wherein the mobile communication devices are organized into a grouping based upon the content, location, and/or temporal state of the phones. The present invention is also a method of targeted advertising on mobile communication devices.

### PRIORITY CLAIM

To the fullest extent permitted, this U.S. Nonprovisional Patent Application hereby claims priority to U.S. Provisional Application 61/631,438, filed Jan. 5, 2012, titled “Method and System for AD HOC Application Centrix PBX.” The title of said provisional was entered incorrectly, as the word “Centrix” should be “Centric.”

### TECHNICAL FIELD

The present invention relates generally to cellular phones and social networks and more specifically to methods and systems of organizing cellular phones and other devices running cellular phone based operating systems into a common exchange, wherein the cellular phones are organized into a grouping based upon the content, location, user preferences and/or temporal state of the phones, and wherein sponsors can target information specific to a particular group.

### BACKGROUND OF THE INVENTION

Cellular phone usage has seen an enormous and consistent growth over the last several years. By the end of year 2011, there were an estimated 6.1 billion cellular subscribers, up from 5.4 billion in 2010, 4.7 billion in 2009, 4.1 billion in 2008 and 1.0 billion in 2002. That represents a 500% growth in 9 years. It is estimated that 87% of the World's population has a cellular phone subscription. By the year 2017, it is estimated that there will be over 9 billion cellular subscribers worldwide with 3 billion of those using smart phones. Web usage via a cellular phone has also grown by leaps and bounds. It is estimated that cellular phone web usage will surpass PC-based web usage in the US by 2015.

The top 3 countries with the largest number of subscribers as of 2012 are: 1) China with approximately 1.1 billion; 2) India with approximately 1.0 billion; and 3) USA with approximately 340 million, wherein these 3 countries combined account for approximately ⅓ of the World's cellular phone usage. At an average of 30 minutes per day per user, worldwide there are approximately 180 billion minutes used per day or 65.7 trillion minutes per year. Growing even faster than the cellular phone itself are downloadable applications (“Apps”). It is estimated that 21.6 billion cellular phone apps will be downloaded in 2013, representing about $30 billion in revenues.

Growing in some respects even faster than the cellular phone industry is social networking services such as Facebook. Facebook was launched in February of 2004, and as of September of 2012, Facebook had over a billion active users and was worth over $100 billion dollars. More than half of Facebook subscribers use a cell phone to connect. Whether for business or pleasure, it is clear that in today's modern society, people desire, if not demand, to be connected. With more than 180 billion cell phone minutes being used per day, any new or improved system that facilitates people's thirst for information and desire to stay connected will prove to be quite popular.

One popular means by which people feed their thirst for information is to connect with groups of people with similar interest. For example, fans of a certain musical group, fans of a sports team, mechanical engineers, players of the game Warcraft, are all examples of connecting with groups of similar interest. Prior to the present invention, one of the most common methods utilized to stay connected based on one's interest, was to join a website and/or join a blog. A person can periodically check the group's website or read/write blogs about their interest. However, this method is relatively static and can result in limited and delayed information.

In addition to staying connected based on interest, there is often a desire to stay connected based on location and/or an event. For example, a GaTech fan attending the rival game of UGA v. GaTech, may choose to bring a radio or use his cellular phone so that he can listen to the more thorough radio sports talk stations while watching the game in person. Another example is a family visiting Disney World. Often times a family will utilize their cellular phone to connect to the park's website to obtain general guidance on rides, restaurants and shows. As one can see, there are numerous ways in which people try to stay connected, more and more via their cellular phones.

The prior method of gathering information or connecting with a defined group via one's cellular phone is deficient and needs improving. For instance, if one is a fan of Band X and would like to connect with Band X and other similar fans, he must open his phone's Internet browser, enter the website if known, if not, then do a search, once landing on their general website he then must sign in and become a member. Subsequently, he may receive emails from Band X fan club regarding news or upcoming concerts. If he wants to connect with other fans, he has to open up his browser, enter the website address (or a link could have been setup thus reducing one step) logon to Band X website and review blogs and make comments; as every fan does not utilize blogs, this method will be very limited. If one is at Band X's concert, even though he is surrounded by other fans, the prior methods of connecting fans did little to provide real time connections.

As another example of how the current methods are deficient, let's consider tradeshows and conventions. At a typical tradeshow, a multitude of products and/or services within a specific industry are displayed in large commercial buildings so that potential buyers can review products and services from a multitude of sellers in one event. One of the largest tradeshows in the U.S. is the National Hardware Show. This tradeshow takes place every year and has over 2500 exhibitors and over 27,000 attendees. While attending, if one would like to connect with all hammer exhibitors, for instance, he would need to log into the tradeshow's website, do a search of product by vendor, and then off on his “100-mile” journey through the tradeshow hoping that 1) he can locate the exhibitor; 2) he can obtain the person's name who is in charge of hammers; and 3) he gets lucky and the person is there. If the person is not there or if the person is already talking with someone, he would have to either wait or go back later and try again; obviously not an efficient use of time. If he wanted to schedule 3-4 lunches and 3-4 dinners with various hammer representatives, he would likely spend more time tracking them down trying to schedule the meetings than he would actually attending them. Additionally, if he wanted to gather information about the various hammers that each manufacturer sells, he would typically have to go to their website and filter through all the other products this company is selling to get to what is important to him, hammers. This is inefficient and counterproductive because the only items he cared about were the hammers. In other words, hammers are #1 in his World, whereas in the manufacturer's World maybe other products come before hammers thus placing hammers in the background and not giving them sufficient attention. On the other hand, if the manufacturer knew each time a visitor came to their website what kind of product that person was interested in, they could redirect that person to the existing relevant pages, to a specialized website or to a local screen thus providing that person information more relevant and targeted to his interest.

It is clear that there is an unmet need for a system that organizes cellular phones into a local exchange based upon various factors such as interest, location, content and/or time thereby nourishing society's immense thirst for information and connectivity.

### BRIEF SUMMARY OF THE INVENTION

Briefly described, in a preferred embodiment, the present invention overcomes the above-mentioned disadvantages and meets the recognized need for such a system by providing cellular phones that can be organized into a local exchange, herein referred to as a private branch exchange (PBX). Preferably via Session Initiation Protocol (SIP), a group of devices running cellular phone based operating systems, such as (but not exclusively) the Android and Apple iOS systems, can call one another, using both voice and video, through the exchange independent of their attachment to a cellular carrier. In an alternate embodiment, the invention further relates to a system that groups devices into a PBX, but also can create a website for each PBX member that is altered from a base template through an XSL rules engine. Thus, the resulting community of cellular phones has a private exchange and private screen view while retaining their native public phone numbers and public access to the Internet.

The present invention results in a significant improvement over the prior methods/systems. For example, in the tradeshow example above, the present invention allows attendees that have an interest in buying, selling or promoting hammers to form an ad hoc exchange based on this interest. The exchange could be a sponsored type of exchange or a community type of exchange. More specifically, one or more of the hammer manufacturers may want to sponsor such an exchange to promote their goods. Alternatively, the exchange could be a community type of exchange meaning the parties sharing a similar interest (hammers in this example) could form the exchange to facilitate the flow of information to and communications with buyers. Whether it's a community type or a sponsored type, useful information such as the location of booths, where-a-bouts of salesmen, schedules and direct communication is made possible thus making an enormous improvement over the prior method.

### BRIEF DESCRIPTION OF THE DRAWINGS

Accordingly, the present disclosure will be understood best through consideration of, and with reference to, the following drawing Figures, viewed in conjunction with the Detailed Description referring thereto, in which like reference numbers throughout the various Figures designate like structure, and in which:

FIG. 1 is a schematic of an embodiment in one of its simplest of forms showing two mobile communication devices communicating via voice/video and being grouped by phone content, location, interest and/or time;

FIG. 2 is a schematic of an embodiment having a multitude of connections grouped together based on location;

FIG. 3 is a schematic of an embodiment having a multitude of connections grouped together based on content/interest; and

FIG. 4 is a schematic of an embodiment having a multitude of connections grouped together based on time.

It is to be noted that the drawings presented are intended solely for the purpose of illustration and that they are, therefore, neither desired nor intended to limit the invention to any or all of the exact details of the system shown, except insofar as they may be deemed essential to the claimed invention.

### DETAILED DESCRIPTION OF THE PREFERRED AND SELECTED ALTERNATE EMBODIMENTS

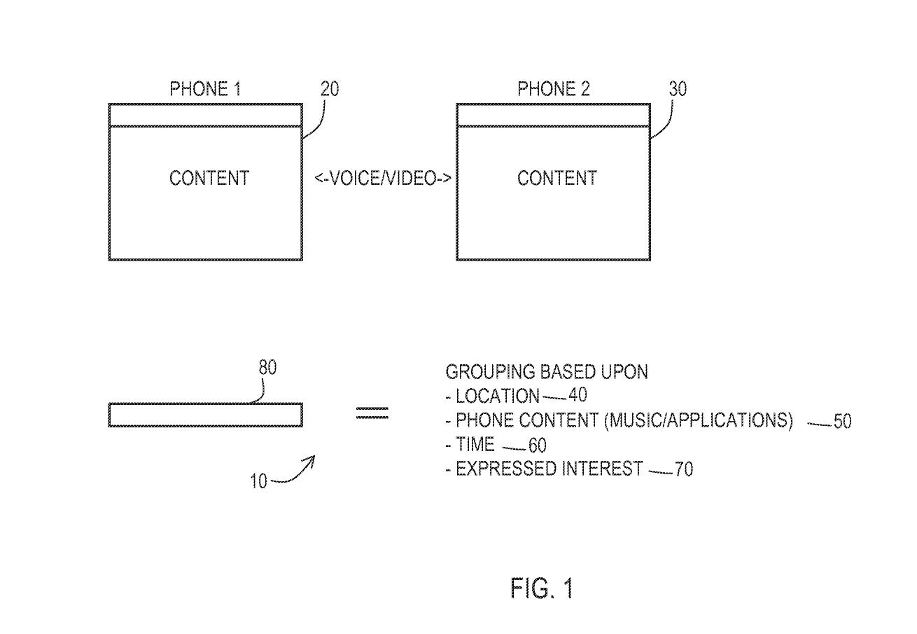

In describing the embodiments of the present invention illustrated in FIGS. 1-4 and other embodiments, specific terminology is employed for the sake of clarity. The claimed invention, however, is not intended to be limited to the specific terminology so selected, and it is to be understood that each specific element includes all technical equivalents that operate in a similar manner to accomplish a similar purpose.

Referring to FIG. 1, there is shown the present invention 10 in one of its simplest forms. First cellular phone 20 and second cellular phone 30 are connected to form an Exchange 80, wherein said phones are grouped based on location 40, content 50, time 60 and/or interest 7, and wherein cellular phones 20 and 30 have a means for data storage thereon such as, SIM and micro-SD cards.

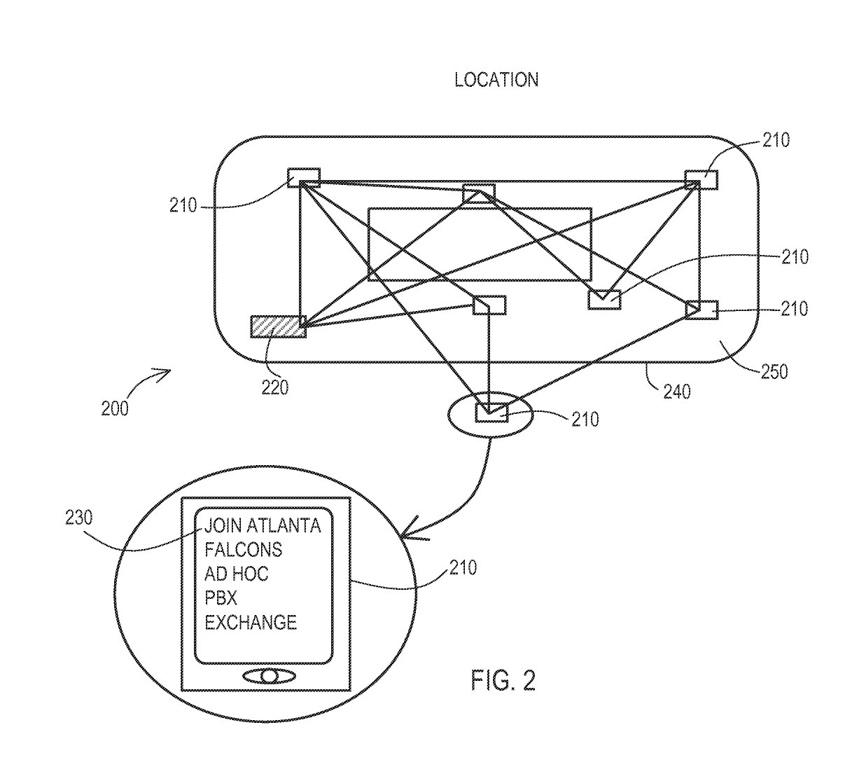

Now referring to FIG. 2, there is shown an alternate embodiment 200 having a multitude of connections grouped together based on location, of which could be pre-saved in data storage, made available via permissions, or pushed out by the user. More specifically, for exemplary purposes only, a stadium 250 is shown wherein a plurality of cellular phones 210 are connected once they enter or come in close proximity to a defined area 240 to said stadium 250 thereby forming an Exchange 220. Preferably, as a user enters the defined area 240, cellular phone 210 in one embodiment displays a welcome screen 230. From there, a user would have a multitude of potential options such as view coupons, view info about Falcons, communicate with other exchange users, find the nearest food stand, receive invitations to VIP events and other choices as desired by the Exchange Organizers, Sponsors and/or the Members.

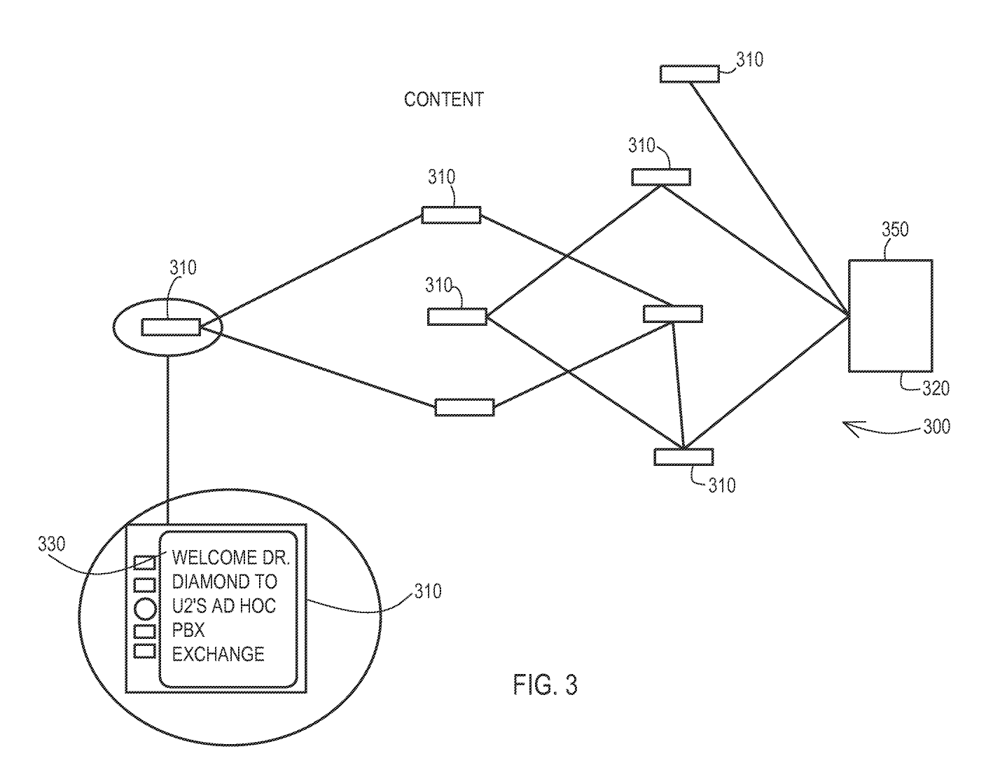

Now referring to FIG. 3, there is shown an alternate embodiment 300 having a multitude of connections grouped together based on content/interest preferably pre-saved in user's data storage. More specifically, for exemplary purposes only, the content/interest is the group U2 350, wherein a user's cellular phone 310 having U2 music content therein could be invited to join the U2 Exchange or alternatively, a user simply having an interest in U2 could join. Once joined, users could receive a welcome notice 310 and then enjoy many benefits such as a special viewing of a concert just for Exchange Members, automatic enrollment in VIP fan club, tour dates, inside information about the members, interviews with the band, communication with other Exchange Members and other choices as desired by the Exchange Organizers, Sponsors and/or the Members.

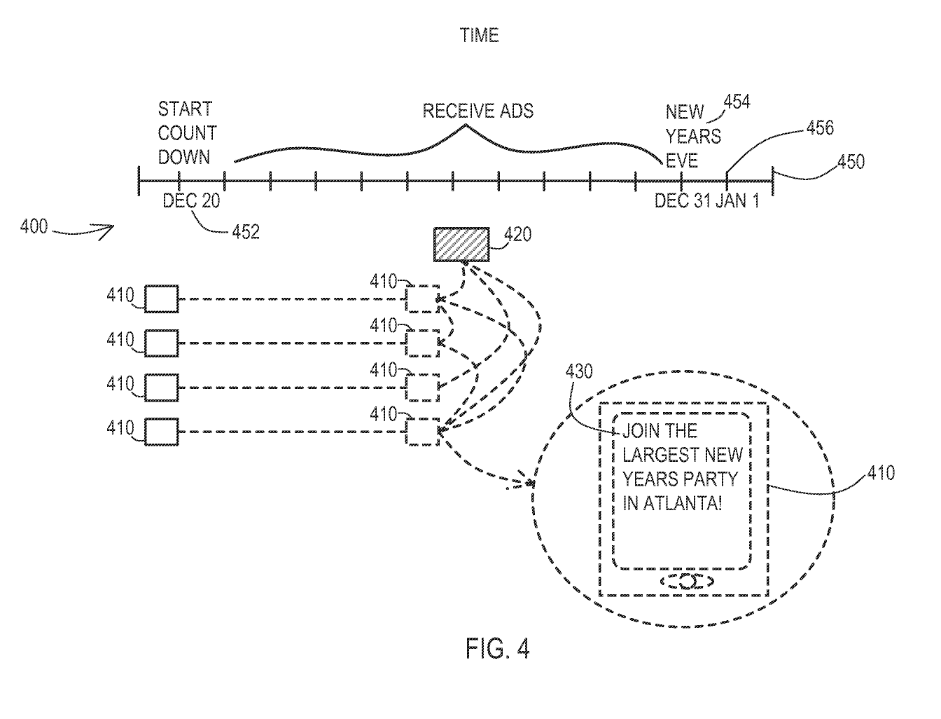

Now referring to FIG. 4, there is shown an alternate embodiment 400 having a multitude of connections grouped together based on time/event. More specifically, for exemplary purposes only, the time/event is New Years—Atlanta 450, wherein a user could have this time event pre-saved in data storage and could join the New Years—Atlanta 450 Exchange 420 via his cellular phone 410 such that at a specific time, i.e., 10 days 452 before New Year's Eve 454 said user could begin to receive a countdown, invites to sponsored parties, special dinners, and many other possibilities surrounding the event 450 as desired by the Exchange Organizers, Sponsors and/or the Members.

Although smart cellular phones are the preferred mobile communication devices, other known mobile communication devices such as, for exemplary purposes and not to limit, laptop computers, tablet computers, PDAs, notebook computers, netbook computers, phablets, UMPCs and hybrids thereof may be utilized.

As for data storage, the SIM and/or micro SD cards attached to each mobile communication device are the preferred means of data storage; however, other known data storage means may be utilized on the mobile communication device or remote therefrom such as, for exemplary purposes and not to limit, memory sticks, non-micro SD cards, smart cards, multimedia cards, flash memory, solid state drive (SSD) memory and hybrid hard drives.

Generally speaking as to one embodiment, this ad hoc PBX is a social “clumping” of phones based on guest accounts. Each could have a slightly different website that they are brought to by the invention. Again the website may look the same on each phone (thought the way the rules engine works it actually could even look different), where the action brought on upon by links are different per phone. The links can bring you to other pages, run requests, or dial phone numbers. Since phone calls in the invention natively can be video calls (or injected video) you get the following social scenarios wherein “phone” is short for any phone operating system based device including tablets. For exemplary purposes only and not to limit the present invention, below are some various alternate embodiments:

1) A phone owner at an amusement park is instructed by signs in the park to use the invention. The invention sees the MAC address or carrier phone number to uniquely identify the device. Since the invention doesn't yet have a match for this phone, it creates a guest account and an associated web site. That web site allows the user to schedule THEIR ride times/check THEIR particular waiting time. The user is called automatically five minutes prior to their ride time. A link with Minnie Mouse's face makes a call that is answered by a pre-recorded video of Minnie. Because the call is a phone call it takes over the entire screen real-estate. Meanwhile, the phone (now part of the local PBX that is set so it doesn't dial out under any circumstance for the guest account) can be called (as it is just another four digit extension) by an actor pretending to be Minnie as a voice call a few minutes later; and

2) The user is a huge Justin Bieber fan. The user has downloaded the invention to their phone. You are instructed by the Bieber Facebook page to install the invention onto your phone. Using the same process above you can see a live concert (limited to a limited number of guest accounts) by Justin by hitting a link that dials a local number that hands the call off to a site that injects the video feed into the call.

The social use paradigm points out the invention's implicit understanding that phones differ from computers. Phones represent identity, take orders from a parent network server, and are only fully functional when networked to a like minded asset.

In one embodiment, there are actually two types of ad hoc sites, sponsored and community. The sponsored is what has been described above. A location, a fan club subject, etc . . . directly would remunerate the invention for the ad hoc website/phone system “clump of phones/individualized websites.” But there is no reason that an individual/group couldn't initiate a clump that is suggested by the invention's drop down list creation. An individual, for example, could start their own Miami based gourmet based version of the invention if the invention software saw that there is a food based application on their Miami based phone. If enough phones were to “enlist” in this community based clump, the invention could approach the food based application company with the “clump” to turn it into a sponsored clump. In the meantime, to foster the growth of community based clumps, advertising dollars could be split between the invention and the originator of the clump.

An important point has to do with the invention's ability to organize the application centric PBX around a base web site that is individualized for each new user. Companies could design their base website as one that is AJAX based. AJAX, for the uninitiated, allows a dynamic website that can update itself without user input. If you have a dynamic AJAX base website, you can have a series of the invention's community of websites/audio-visual phones that not only are tweaked for each user at ad hoc creation, but is constantly tweaked and updated based on what other members of the clump are doing. It becomes trivial to create a use of the invention that doesn't need a “Refresh” button and is much more multimedia rich than could otherwise be created because it is treating the phone “as a phone” and not just a device with a web browser.

The list of available PBXs associated with the invention is based on multiple vectors. As opposed to on the Internet, where you direct the browser based on an interest and receive a piece of information, the community you join (i.e. the bunch of phones in the invention) can be based on multiple vectors. The amusement park scenario can be location based. Based on your location at the amusement park, the park gets added to your drop down list, wherein if you join it you would now get access to the personalized ride scheduler, call back system, the video chat with Minnie Mouse link, etc. . . . You could have time based groups—i.e. based on a religious holiday or date of a sporting event. You can music fan club groups based on the music on your phone. You can have groups based on the apps you have on your phone. Combinations of information could suggest more specific grouping. Ultimately, the biological perspectives of person, place, and time (with the option of typing in even more data) are used to select the appropriate the ad hoc community a phone could join. At its fullest extent, if the model is as striking as this author perceives, a pictorial description of the Internet, which today could be described by linear links, would take the form of interwoven circles.

What is claimed is:

1. A system for sharing information, compromising:
at least two mobile communication devices wirelessly communicable between each other;
at least two means for storing data each communicable with each of said mobile communication devices and capable of receiving, storing and retrieving data, wherein said mobile devices have at least two states selectable between a closed-communication state and an open-communication state, and wherein based on said data on said mobile communication devices, the state of said mobile device is changeable to either said open or said closed state, wherein in said open state, said mobile communication devices are communicable with other mobile devices in said open state.

2. The system for sharing information of claim 1, wherein said data pertains to the location of said mobile communication device.

3. The system for sharing information of claim 1, wherein said mobile communication device contains retrievably stored therein user preferences and wherein said data pertains to said user preferences of said mobile communication device.

4. The system for sharing information of claim 1, wherein said data pertains to a temporal event.

5. The system for sharing information of claim 1, wherein said means for storing data is at least one memory stick carried by said mobile communication device.

6. The system for sharing information of claim 1, wherein said means for storing data is at least one SD card carried by said mobile communication device.

7. The system for sharing information of claim 1, wherein said means for storing data is at least one SIM card carried by said mobile communication device.

8. The system for sharing information of claim 1, wherein said means for storing data is at least one smart card carried by said mobile communication device.

9. The system for sharing information of claim 1, wherein said means for storing data is at least one multimedia card carried by said mobile communication device.

10. The system for sharing information of claim 1, wherein said means for storing data is flash memory carried by said mobile communication device.

11. The system for sharing information of claim 1, wherein said means for storing data is solid state drive (SSD) memory carried by said mobile communication device.

12. The system for sharing information of claim 1, wherein said means for storing data is flash memory remote from said mobile communication device.

13. The system for sharing information of claim 1, wherein said means for storing data is at least one hard disk drive remote from said mobile communication device.

14. The system for sharing information of claim 1, wherein said means for storing data is at least one hybrid hard drive remote from said mobile communication device, wherein said hybrid hard drive is a hybrid between flash memory and hard drive memory.

15. The system for sharing information of claim 1, further comprising a server viewable by said mobile communication device based on said data.

16. The system for sharing information of claim 1, wherein said mobile communication device is a cellular phone.

17. The system for sharing information of claim 1, wherein said mobile communication device is a tablet computer.

18. The system for sharing information of claim 1, wherein said mobile communication device is a laptop computer.

19. The system for sharing information of claim 1, wherein said mobile communication device is a PDA.

20. The system for sharing information of claim 1, wherein said mobile communication device is a phablet.

21. The system for sharing information of claim 1, wherein said mobile communication device is a netbook computer.

22. The system for sharing information of claim 1, wherein said mobile communication device is a notebook computer.

23. The system for sharing information of claim 1, wherein said mobile communication device is a Ultra-Mobile PC (UMPC).

24. The system for sharing information of claim 1, wherein said mobile communication device is a Mobile Internet Device (MID).

25. The system for sharing information of claim 1, wherein said mobile communication device is a hybrid computer/cellular phone.

26. Apparatus for connecting to an exchange, comprising:
a mobile communication device selectively communicable with other mobile communication device;
means for storing data, wherein said means for storing data is communicable with said mobile communication device;
means for reading said data, wherein said means for reading data is communicable with said mobile communication device, and wherein said mobile communication device has at least two states selectable between close and open, wherein based on said data the state of said mobile communication devices is changeable from said closed state to said open state, and wherein when in said open state, said mobile communication device is communicable with other mobile communication devices also in said open state.

27. The apparatus for connecting to an exchange of claim 26, wherein said data pertains to the location of said mobile communication device.

28. The apparatus for connecting to an exchange of claim 26, wherein said mobile communication device contains retrievably stored therein user preferences and wherein said data pertains to said user preferences of said mobile communication device.

29. The apparatus for connecting to an exchange of claim 26, wherein said data pertains to a temporal event.

30. The apparatus for connecting to an exchange of claim 26, wherein said means for storing data a memory stick carried by said mobile communication device.

31. The apparatus for connecting to an exchange of claim 26, wherein said means for storing data is a hard disk drive remote from said mobile communication device.

32. The system for sharing information of claim 26, wherein said mobile communication device is a cellular phone.

33. The system for sharing information of claim 26, wherein said mobile communication device is a tablet computer.

34. The system for sharing information of claim 26, wherein said mobile communication device is a laptop computer.

35. Method for creating a pbx exchange compromising the steps of:
a) providing at least two mobile communication devices wherein said devices are wirelessly communicable between each other;
b) providing at least one exchange server communicable with said at least two mobile communication devices, wherein said at least one exchange server can be activated to be communicable with selected mobile communication devices based on the respective user data selected from the group consisting of location, preferences, time and event, wherein said mobile communication devices have at least two states selectable between closed (not communicating) and open (communicable), wherein based on said user data said state of said mobile communication device is changeable between said open and said closed state; and
c) providing a network specific to and available for members of a selected group based on said user data to allow the exchange of information freely within said exchange.

36. The method for creating a pbx exchange of claim 35, wherein said open state has at least two sub-states open visible, open not visible, wherein said mobile communication device is visible to other mobile devices within said system when in said open-visible state, and wherein said mobile communication device is not visible to other said mobile communication devices when in said open-not visible state.

37. The method for creating a pbx exchange of claim 35, further comprising the additional states of open stand-by, open-active and closed stand-by.

38. The method for creating a pbx exchange of claim 35, wherein said mobile communication device is a cellular phone.

39. The method for creating a pbx exchange of claim 35, wherein said mobile communication device is a tablet computer.

40. The method for creating a pbx exchange of claim 35, wherein said mobile communication device is a laptop computer.

41. An ad hoc pbx exchange network, compromising:
at least one searchable mobile communication device having a display screen, a web browser, and retrievable user data, wherein said mobile communication device is capable of receiving and sending audio, video and commands;
at least one computer server capable of requesting and receiving said user data and broadcasting a command, video and/or audio to said at least one mobile communication device to control said screen of said at least one mobile communication device via said commands, thereby forming a community wherein said at least one mobile communication device within said community is adapted to receive and display differing content delivered to said at least one mobile communication device, and wherein additional mobile communication devices may be added to said community based on user data on each of said additional mobile communication device; and
means for searching said user data of each of said mobile devices within the community, wherein members can be reached by expressing, either through speaking or typing, a desire for a type of person in the community without needing to know the phone number or name of the person.

42. The ad hoc pbx exchange network of claim 41, wherein said mobile communication device is a cellular phone.

43. The ad hoc pbx exchange network of claim 41, wherein said mobile communication device is a tablet computer.

44. The ad hoc pbx exchange network of claim 41, wherein said mobile communication device is a laptop computer.

45. The ad hoc pbx exchange network of claim 41, wherein said user data comprises at least the location of said mobile communication device.

46. The ad hoc pbx exchange network of claim 41, wherein said user data comprises at least one user preference.

47. The ad hoc pbx exchange network of claim 41, wherein said user data comprises at least one event.

48. The ad hoc pbx exchange network of claim 41, wherein said user data comprises at least one temporal period.

49. The ad hoc pbx exchange network of claim 41, wherein said means for searching said user data is a file crawler program.

50. The ad hoc pbx exchange network of claim 41, wherein said means for searching said user data is an indexing search program.

51. The ad hoc pbx exchange network of claim 41, wherein said means for searching said user data is a text searching program.

52. The ad hoc pbx exchange network of claim 41, wherein said means for searching said user data is a metadata search program.

53. Method of advertising to selected mobile communication devices, compromising the steps of:
a) providing at least two mobile communication devices each having retrievable user data associated therewith wherein said devices are wirelessly communicable between each other;
b) providing at least one exchange server capable of retrieving and broadcasting advertisements to said at least two mobile communication devices, wherein said at least one exchange server can be activated to be communicable with selected mobile communication devices based on said user data; and
c) providing a network specific to and available for members of a selected group to allow the exchange of information freely within said exchange.

54. The method of advertising to selected mobile communication devices of claim 53, wherein said mobile communication device is a cellular phone.

55. The method of advertising to selected mobile communication devices of claim 53, wherein said mobile communication device is a tablet computer.

56. The method of advertising to selected mobile communication devices of claim 53, wherein said mobile communication device is a laptop computer.

57. The method of advertising to selected mobile communication devices of claim 53, wherein said user data comprises at least the location of said mobile communication device.

58. The method of advertising to selected mobile communication devices of claim 53, wherein said user data comprises at least one user preference.

59. The method of advertising to selected mobile communication devices of claim 53, wherein said user data comprises at least one event.

60. The method of advertising to selected mobile communication devices of claim 53, wherein said user data comprises at least one temporal period.

61. An ephemeral expandable and diminishable phone system that adapts to the perspectives (who/when/where) of the members of a community to route audio/visual information, comprising:
at least one searchable mobile communication device having a display screen, a web browser, and searchable user data, said mobile communication device capable of receiving and sending audio, video, and commands; and
at least one server capable of broadcasting a command, video and/or audio to said at least one mobile communication device to control said screen of said at least one mobile communication device via issuing of said commands to the phone's web browser thereby forming a community, wherein said at least one mobile communication device can have differing content delivered to said at least one mobile communication device which may continue to alter over time, and wherein additional mobile communication devices may be added to the community based on said user data comprising location, calendar content and/or phone content; and wherein members can be reached by searching a type of person and/or his associations in the community without needing to know the phone number or name of the person.

62. The ephemeral non-permanent phone system of claim 61, wherein said user data comprises at least one user preference.

63. The ephemeral non-permanent phone system of claim 61, wherein said user data comprises at least one event.

64. The ephemeral non-permanent phone system of claim 61, wherein said user data comprises at least one temporal period.
